(19) United States
(12) Patent Application Publication
(10) Pub. No.: US 2024/0127319 A1
(43) Pub. Date: Apr. 18, 2024

(54) IN-FLIGHT CATER SOFTWARE APPLICATION

(71) Applicant: In-Flight Cater Inc, East Point, GA (US)

(72) Inventor: Ryan Evelyn, Atlanta, GA (US)

(73) Assignee: In-Flight Cater Inc, East Point, GA (US)

(21) Appl. No.: 18/486,087

(22) Filed: Oct. 12, 2023

Related U.S. Application Data
(60) Provisional application No. 63/379,366, filed on Oct. 13, 2022.

(51) Int. Cl. G06Q 30/0601; G06Q 50/12; G06Q 50/30

(52) U.S. Cl. CPC G06Q 30/0635; G06Q 50/12; G06Q 50/30

(57) ABSTRACT

The system and methods disclosed provide a platform system, including computer software applications (apps) and a backend system that can be used to provide in-flight catering services for passengers on a flight in an automated manner. A passenger mobile application can be used by a passenger to electronically create an in-flight catering order using a mobile computer device. A flight attendant mobile application allows a flight attendant to electronically retrieve and view the passengers in-flight catering order via a mobile computer device. The in-flight catering service platform system provides various features that add automation, security, and increased efficiency to aspects of in-flight catering services that are not currently available. The in-flight catering service platform system is distinctly designed to provide a technology platform that consistently, efficiently, and interactively manages the end-to-end in-flight catering process, with limited “in-person” interaction.

### FIELD OF DISCLOSURE

The present disclosure generally relates to interactive wireless communication, particularly a wireless communication-based platform that facilitates meal services during travel in a vehicle, such as an airplane.

### RELATED APPLICATION

Under provisions of 35 U.S.C. § 119(e), the Applicant claim the benefit of U.S. provisional application No. 63/379,366, filed Oct. 13, 2022, which is incorporated herein by reference. It is intended that each of the referenced applications may be applicable to the concepts and embodiments disclosed herein, even if such concepts and embodiments are disclosed in the referenced applications with different limitations and configurations and described using different examples and terminology.

### BACKGROUND OF THE DISCLOSURE

Airline meal services, also referred to herein as in-flight catering, is a service that provides meals and other products (e.g., beverages, snacks, etc.) to passengers on-board various types of airplanes and aircraft, such as commercial airliners. Typically, these airline meals are prepared by specialist airline catering services; where passengers directly communicate their meal selection to the flight attendants during the flight, and the passengers are subsequently served by the flight attendants using an airline service trolley.

Airline meal services vary widely in quality and quantity across different airline companies and classes of travel. For example, airline meal services can range from a simple snack or beverage in short-haul economy class to a seven-course gourmet meal in a first-class long-haul flight. The types of food offered by these services also vary widely from country to country, and often incorporate elements of local cuisine, sometimes both from the origin and destination countries. Thus, most current airline meal services are significantly reliant on “in-person” communication between the passengers and the flight attendants during the flight. However, as air travel continues to grow, thereby increasing the number of air passengers, it would be beneficial to move away from the tradition “in-person” ordering that is involved in airline meal services and provide services in a manner that is automated and more efficient for both passengers and airline staff (e.g., flight attendants).

### BRIEF OVERVIEW

Both the foregoing brief overview and the following detailed description provide examples and are explanatory only. Accordingly, the foregoing brief overview and the following detailed description should not be considered to be restrictive. Further, features or variations may be provided in addition to those set forth herein. For example, embodiments may be directed to various feature combinations and sub-combinations described in the detailed description.

Additional aspects of the disclosure will be set forth in part in the description which follows, and in part will be obvious from the description, or can be learned by practice of the disclosure. The advantages of the disclosure will be realized and attained by means of the elements and combinations particularly pointed out in the appended claims. It is to be understood that both the foregoing general description and the following detailed description are and explanatory only and are not restrictive of the disclosure, as claimed.

### BRIEF DESCRIPTION OF THE DRAWINGS

The accompanying drawings, which are incorporated in and constitute a part of this disclosure, illustrate various embodiments of the present disclosure. The drawings contain representations of various trademarks and copyrights owned by the Applicants. In addition, the drawings may contain other marks owned by third parties and are being used for illustrative purposes only. All rights to various trademarks and copyrights represented herein, except those belonging to their respective owners, are vested in and the property of the Applicants. The Applicants retain and reserve all rights in their trademarks and copyrights included herein, and grant permission to reproduce the material only in connection with reproduction of the granted patent and for no other purpose.

Furthermore, the drawings may contain text or captions that may explain certain embodiments of the present disclosure. This text is included for illustrative, non-limiting, explanatory purposes of certain embodiments detailed in the present disclosure.

FIG. 1 illustrates an example of a communication system in which embodiments disclosed herein may be implemented for providing an in-flight catering service platform system, according to one or more embodiments shown and described herein.

FIG. 2-FIG. 5 illustrate example graphical user interfaces that may be implemented by the flight attendant mobile application of the in-flight catering service platform system shown in FIG. 1, according to one or more embodiments shown and described herein.

FIG. 6-FIG. 13 illustrate example graphical user interfaces that may be implemented by the passenger mobile application of the in-flight catering service platform system shown in FIG. 1, according to one or more embodiments shown and described herein.

FIG. 14 depicts an example of a method for implementing a computer-based in-flight catering service process, according to one or more embodiments shown and described herein.

FIG. 15A-FIG. 15B depict another example of a method for implementing a computer-based in-flight catering service process, according to one or more embodiments shown and described herein.

FIG. 16 depicts an example of a computer system that may be used in implementing the in-flight catering service platform system, according to one or more embodiments shown and described herein.

### DETAILED DESCRIPTION OF THE DISCLOSURE

The present disclosure includes many aspects and features. Moreover, while many aspects and features relate to, and are described in, the context of a wireless platform providing in-flight catering services, embodiments of the present disclosure are not limited to use only in this context. The present disclosure can be understood more readily by reference to the following detailed description of the disclosure and the Examples included therein.

Before the present articles, systems, apparatuses, and/or methods are disclosed and described, it is to be understood that they are not limited to specific methods unless otherwise specified, or to particular materials unless otherwise specified, as such can, of course, vary. It is also to be understood that the terminology used herein is for the purpose of describing particular aspects only and is not intended to be limiting. Although any methods and materials similar or equivalent to those described herein can be used in the practice or testing of the present disclosure, example methods and materials are now described.

### A. Definitions

It is also to be understood that the terminology used herein is for the purpose of describing particular aspects only and is not intended to be limiting. As used in the specification and in the claims, the term “comprising” can include the aspects “consisting of” and “consisting essentially of” Unless defined otherwise, all technical and scientific terms used herein have the same meaning as commonly understood by one of ordinary skill in the art to which this disclosure belongs. In this specification and in the claims which follow, reference will be made to a number of terms which shall be defined herein.

As used in the specification and the appended claims, the singular forms “a,” “an” and “the” include plural referents unless the context clearly dictates otherwise. Thus, for example, reference to “an opening” can include two or more openings.

Ranges can be expressed herein as from one particular value, and/or to another particular value. When such a range is expressed, another aspect includes from the one particular value and/or to the other particular value. Similarly, when values are expressed as approximations, by use of the antecedent ‘about,’ it will be understood that the particular value forms another aspect. It will be further understood that the endpoints of each of the ranges are significant both in relation to the other endpoint, and independently of the other endpoint. It is also understood that there are a number of values disclosed herein, and that each value is also herein disclosed as “about” that particular value in addition to the value itself. For example, if the value “10” is disclosed, then “about 10” is also disclosed. It is also understood that each unit between two particular units are also disclosed. For example, if 10 and 15 are disclosed, then 11, 12, 13, and 14 are also disclosed.

As used herein, the terms “about” and “at or about” mean that the amount or value in question can be the value designated some other value approximately or about the same. It is generally understood, as used herein, that it is the nominal value indicated ±10% variation unless otherwise indicated or inferred. The term is intended to convey that similar values promote equivalent results or effects recited in the claims. That is, it is understood that amounts, sizes, formulations, parameters, and other quantities and characteristics are not and need not be exact, but can be approximate and/or larger or smaller, as desired, reflecting tolerances, conversion factors, rounding off, measurement error and the like, and other factors known to those of skill in the art. In general, an amount, size, formulation, parameter or other quantity or characteristic is “about” or “approximate” whether or not expressly stated to be such. It is understood that where “about” is used before a quantitative value, the parameter also includes the specific quantitative value itself, unless specifically stated otherwise.

The terms “first,” “second,” “first part,” “second part,” and the like, where used herein, do not denote any order, quantity, or importance, and are used to distinguish one element from another, unless specifically stated otherwise.

As used herein, the terms “optional” or “optionally” means that the subsequently described event or circumstance can or cannot occur, and that the description includes instances where said event or circumstance occurs and instances where it does not. For example, the phrase “optionally affixed to the surface” means that it can or cannot be fixed to a surface.

Moreover, it is to be understood that unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is no way intended that an order be inferred, in any respect. This holds for any possible non-express basis for interpretation, including matters of logic with respect to arrangement of steps or operational flow; plain meaning derived from grammatical organization or punctuation; and the number or type of aspects described in the specification.

Disclosed are the components to be used to manufacture the disclosed apparatuses, systems, and articles of the disclosure as well as the apparatuses themselves to be used within the methods disclosed herein. These and other materials are disclosed herein, and it is understood that when combinations, subsets, interactions, groups, etc. of these materials are disclosed that while specific reference of each various individual and collective combinations and permutation of these materials cannot be explicitly disclosed, each is specifically contemplated and described herein. For example, if a particular material is disclosed and discussed and a number of modifications that can be made to the materials are discussed, specifically contemplated is each and every combination and permutation of the material and the modifications that are possible unless specifically indicated to the contrary. Thus, if a class of materials A, B, and C are disclosed as well as a class of materials D, E, and F and an example of a combination material, A-D is disclosed, then even if each is not individually recited each is individually and collectively contemplated meaning combinations, A-E, A-F, B-D, B-E, B-F, C-D, C-E, and C-F are considered disclosed. Likewise, any subset or combination of these is also disclosed. Thus, for example, the sub-group of A-E, B-F, and C-E would be considered disclosed. This concept applies to all aspects of this application including, but not limited to, steps in methods of making and using the articles and apparatuses of the disclosure. Thus, if there are a variety of additional steps that can be performed it is understood that each of these additional steps can be performed with any specific aspect or combination of aspects of the methods of the disclosure.

It is understood that the apparatuses and systems disclosed herein have certain functions. Disclosed herein are certain structural requirements for performing the disclosed functions, and it is understood that there are a variety of structures that can perform the same function that are related to the disclosed structures, and that these structures will typically achieve the same result.

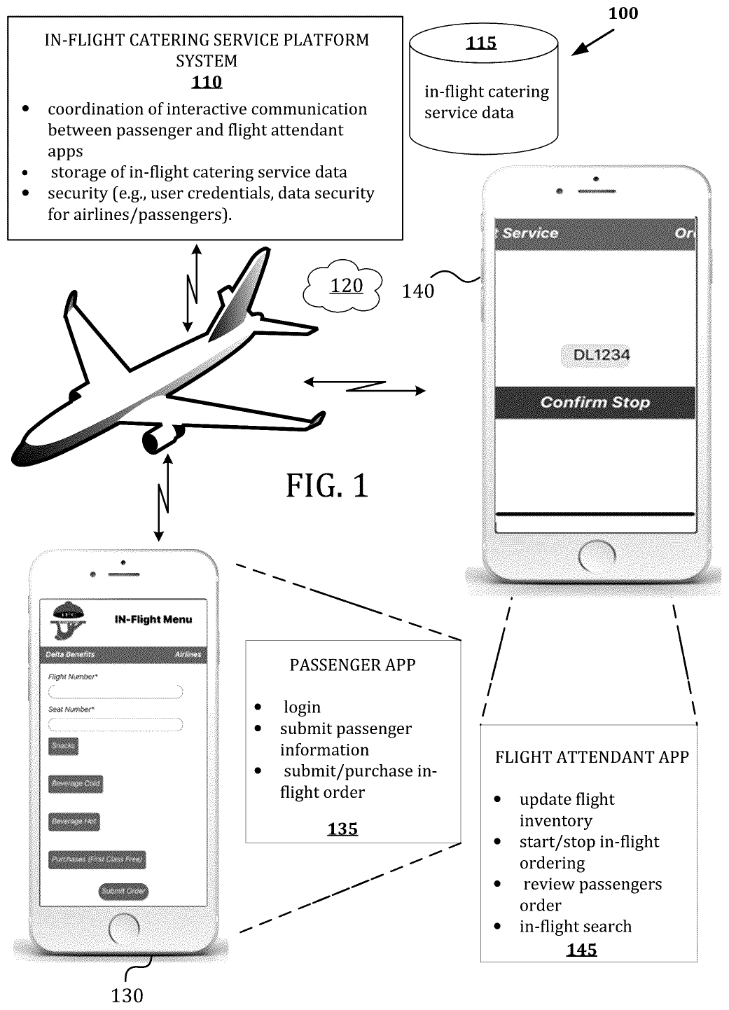

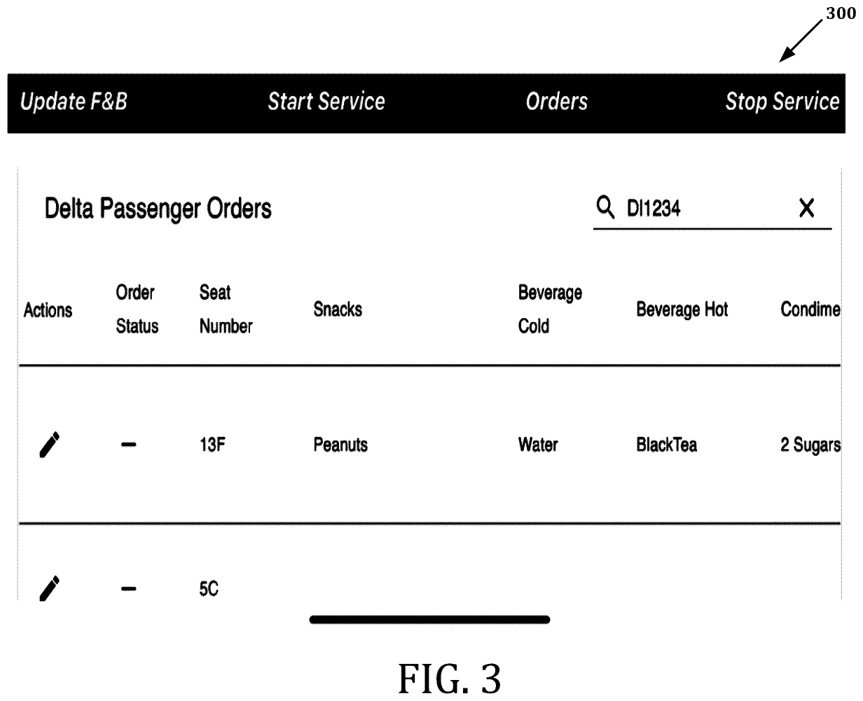

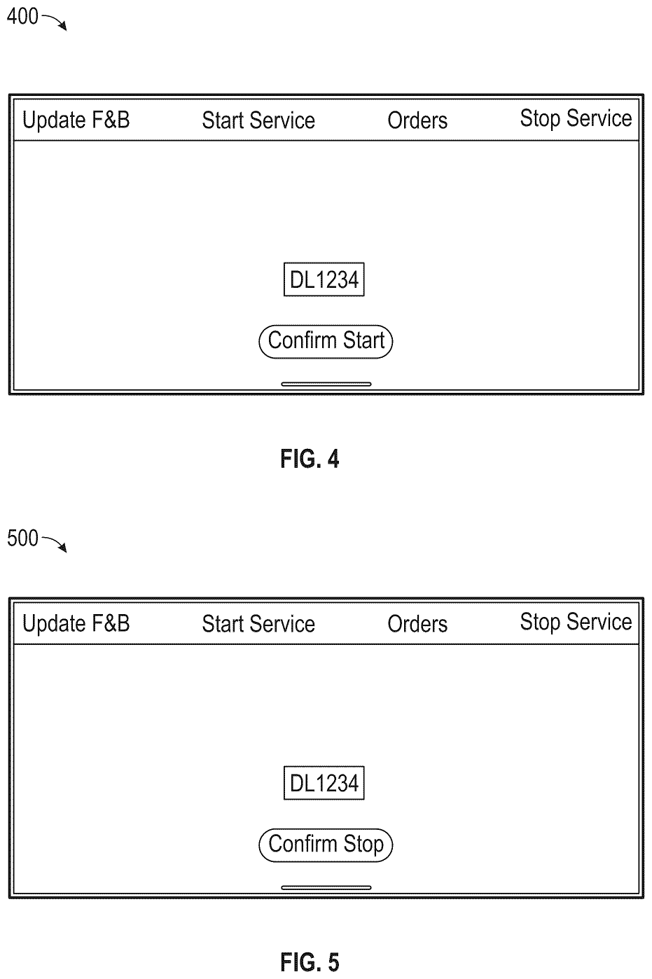

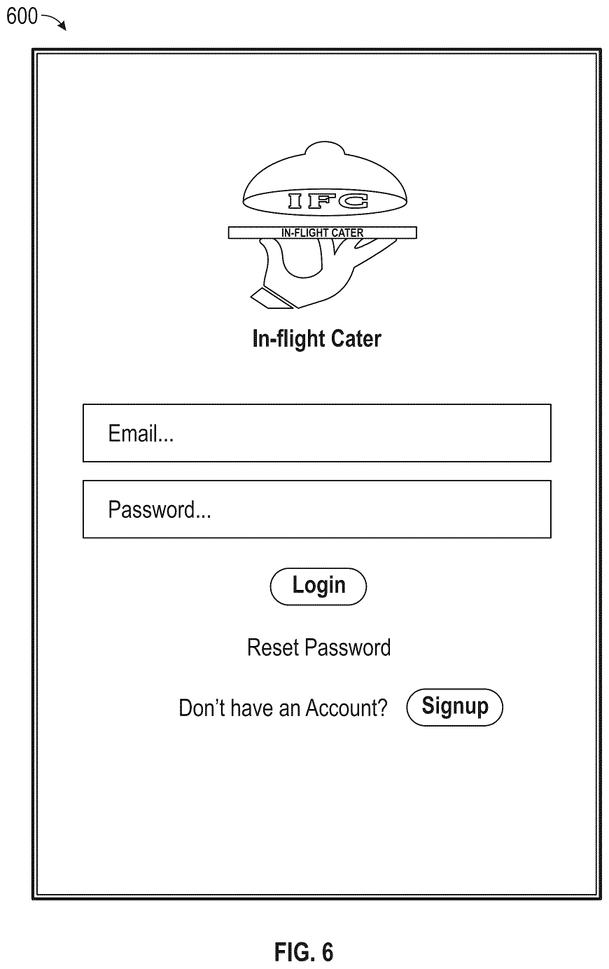

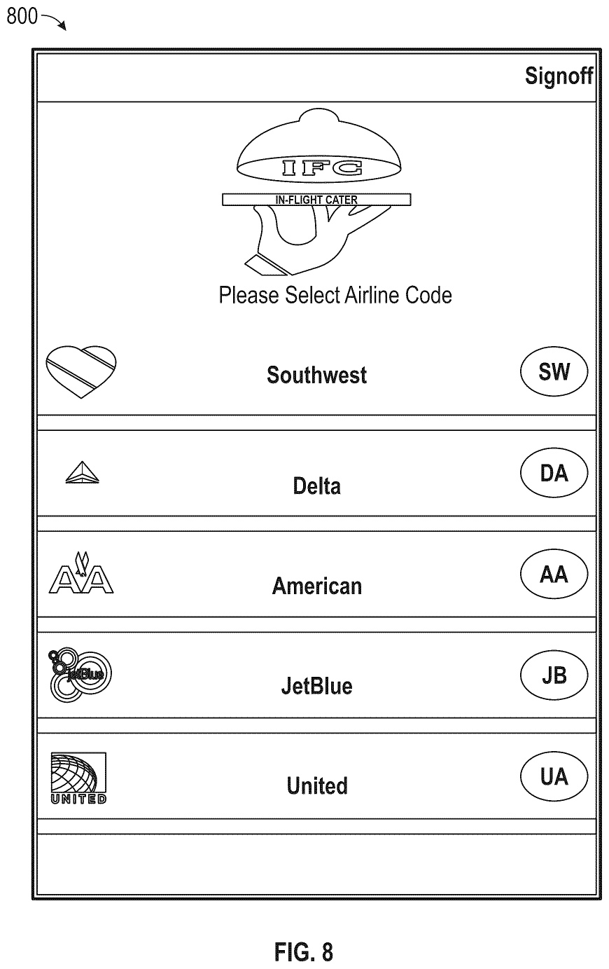

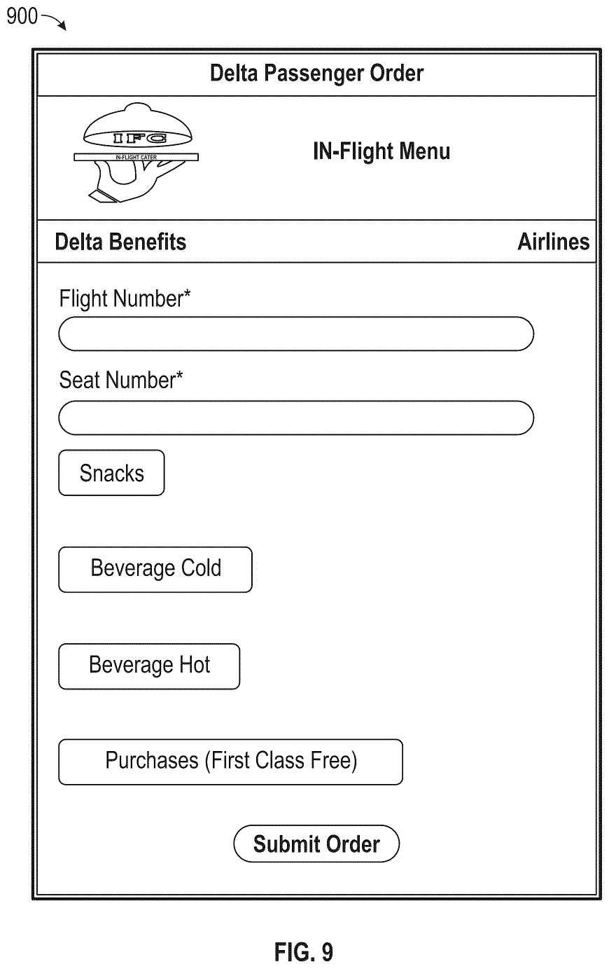

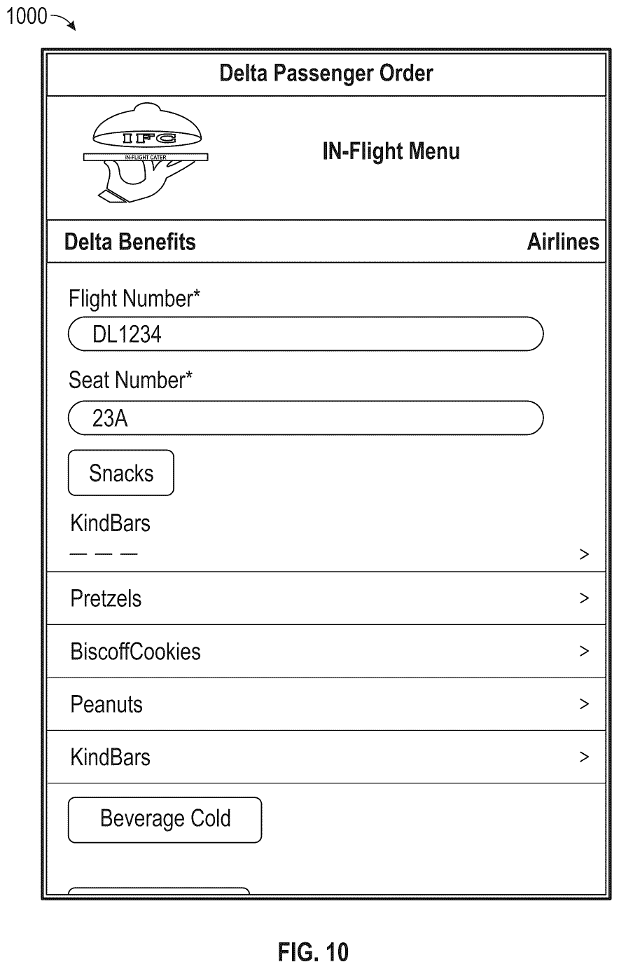

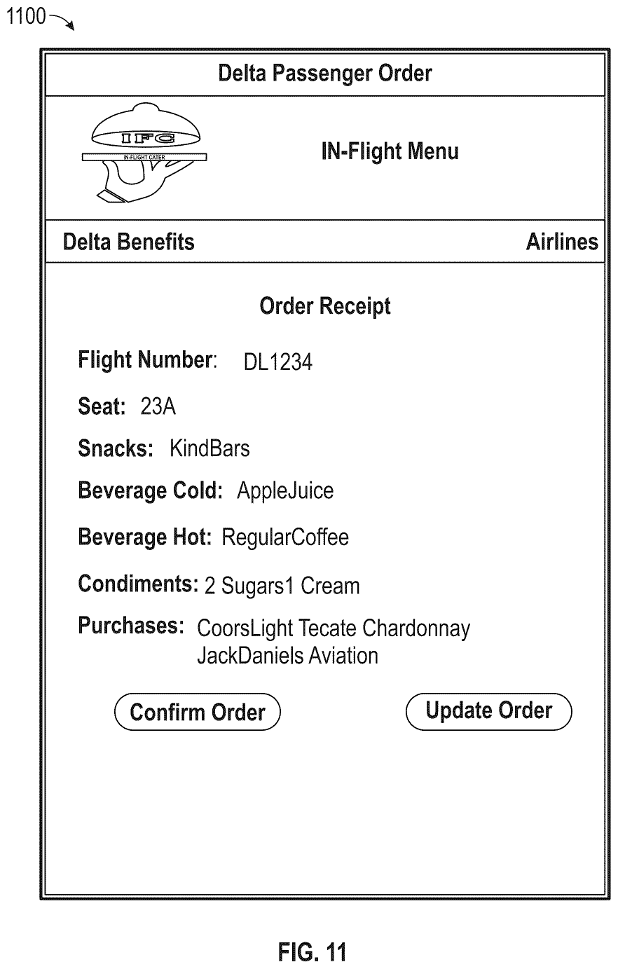

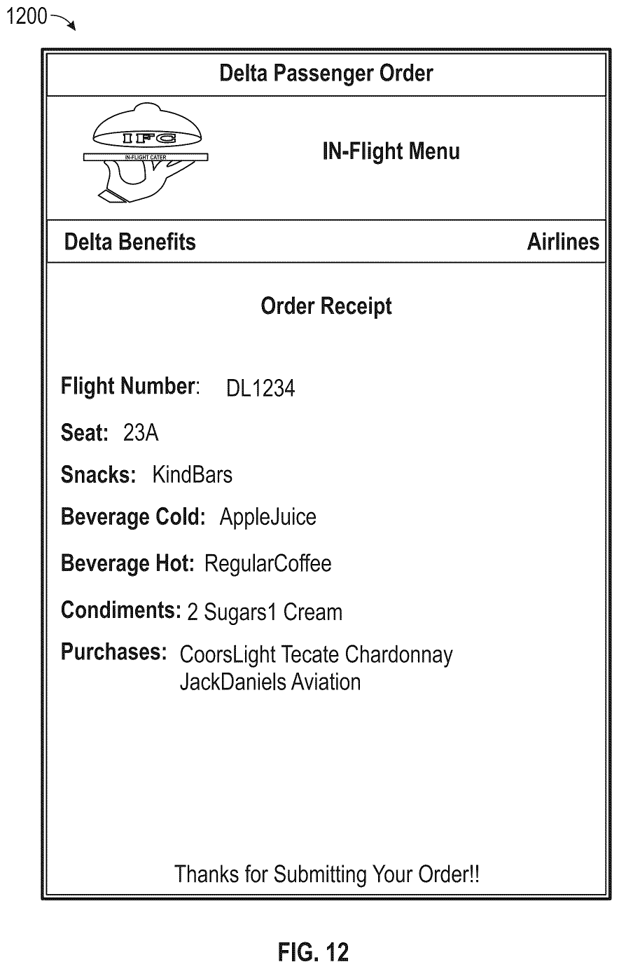

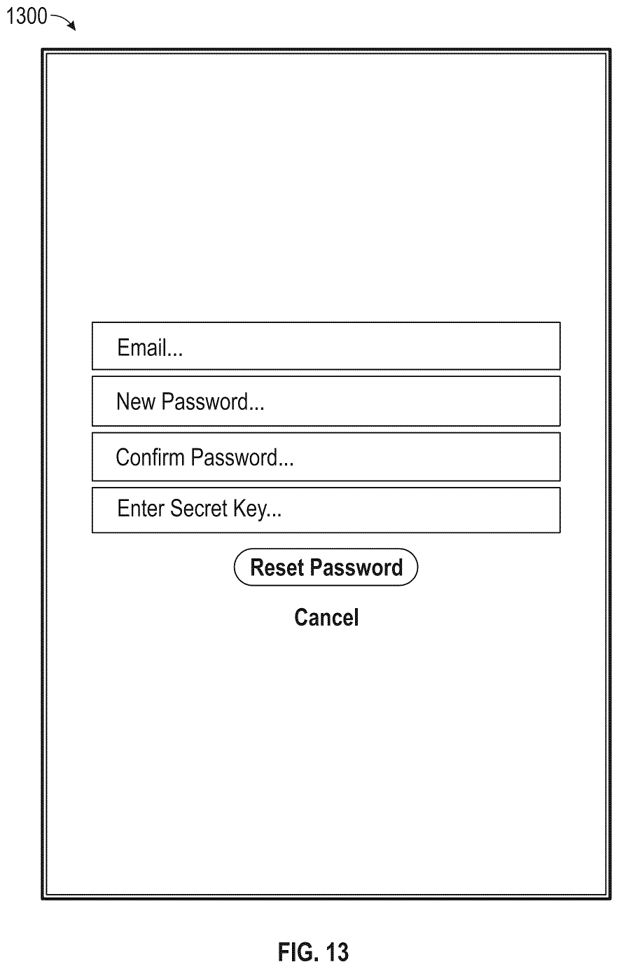

With reference now to the drawings, and in particular FIG. 1 through FIG. 16 thereof, examples of the wireless platform for providing in-flight catering services and the principles and concepts thereof will be described.

The system and methods disclosed herein can be described as a software platform system that is based on wireless communications, including computer software applications (apps) and a backend system, which can be used to provide in-flight catering services. Thus, the disclosed embodiment provides a technology platform that consistently, efficiently, and interactively manages the end-to-end catering process and ultimately ensures the highest level of in-flight dining for any airline, from any location, and on any flight.

In an embodiment, the in-flight catering service platform supports hardware and software applications (e.g., mobile “apps”) that can be installed on a mobile computing device used by passenger(s) of an airplane, and on a mobile computing device used by staff, such as flight attendants, of the airplane. The passenger mobile application supports various interactive features that may be useful for the passenger in the end-to-end in-flight catering services process, such as: secure log-in; airline selection; flight-specific selection (e.g., flight number, seat number, etc.); in-flight menu/order selection; and order confirmation. The flight attendant mobile application supports interactive features that may be useful for the flight attendant in the end-to-end in-flight catering services process, such as: update flight inventory; start/stop in-flight ordering; review passenger order; and in-flight search (e.g., inventory, passenger orders).

In an embodiment, the in-flight catering service platform includes a backend system that provides various features necessary to properly support the end-to-end catering process, such as: coordination of interactive communication between passenger and flight attendant mobile applications; storage of the in-flight catering service data (e.g., airlines, flights, food/beverage inventory, passengers, passenger order data, and the like); and security (e.g., user credentials, data security for airlines/passengers). Additionally, in an embodiment, the in-flight catering service platform leverages wireless communications, such as airplanes with Wi-Fi connectivity, to support the interactive communication between elements of the platform, such as the passenger and flight attendant mobile applications.

Referring now to FIG. 1, an example of a communication environment 100 in which embodiments of the in-flight catering service platform system 110, disclosed herein, may be implemented. The in-flight catering service platform system 110 provides various features that add automation, security, and increased efficiency to aspects of in-flight catering services that is not currently available. As alluded to above, the in-flight catering service platform system 110 is distinctly designed to provide a technology platform that consistently, efficiently, and interactively manages the end-to-end in-flight catering process and ultimately ensures the highest level of in-flight dining for any airline, from any location, and on any flight.

The global market for in-flight catering services is projected to reach $22.4 billion by 2025, which is driven by the unprecedented rise in air passenger traffic. As more people chose flying as their preferred means of travel, it has led to an increase in demand for available food and/or beverage options on flights, as well as a desire for airlines to improve their in-flight catering services, such as providing more convenient services and serving gourmet food catering, as a strategy for service differentiation among other competitor companies.

Moreover, due to the recent COVID-19 pandemic, there has been a large-scale push to drastically reduce the need for “in-person” contact in public environments, particularly in the realm of air travel and transportation. In turn, it has become recently more desirable throughout the world to replace tasks that traditionally involved “in-person” contact with computer-aided and/or automated interactions. The in-flight catering service platform system 110 allows passengers on an airplane to utilize a mobile computer, such as their smartphone, to conveniently order in-flight catering services as a computer-aided interaction, while avoiding unnecessary direct communication between them and their flight attendant (e.g., reducing the potential spread of COVID-19 and other viruses).

As previously described, traditional in-flight catering services involve airline passengers having to wait until a designated portion of the flight when the flight attendants physically go through the cabin, having a “face-to-face” interaction with each passenger to ask for their food and/or beverage requests. During this “in-person” process most of the passengers need time to think about what items they would like to order, which causes delays in the in-flight catering process and increases the amount of time that it takes for passengers to receive service. Furthermore, the conventional “in-person” approach for in-flight catering service is susceptible to human error, such as incorrect/incomplete orders, confusing passengers, and the like. In contrast, the disclosed in-flight catering service platform system 110 realizes multiple advantages associated with leveraging a computer-based platform for automating the in-flight catering service process, such as accuracy, consistency, and efficiency. Furthermore, the in-flight catering service platform system 110 is designed to provide a plethora of ease-of-use related advantages for passengers onboard a flight, such as: providing the passengers with enough information to make informed decisions; allowing passengers to focus and experience the full pleasure of the moment in travelling; reducing wait times associated with ordering in-flight catering services; eliminating frustration with lack of visibility of unavailable items; and limiting interruptions (e.g., flight attendants waking passengers to asking for food/beverage orders). The in-flight catering service platform system 110 is also designed to provide several advantages for the airline staff, particularly flight attendants, onboard a flight, such as: reducing multitasking times to allow focus on primary task (e.g., safety of passengers); reducing confusion and mistakes associated with verbally obtaining passenger orders; and improving focus by eliminating superfluous tasks. It should be appreciated these aforementioned advantages are not intended to be limiting, and that the in-flight catering service platform system 110 provide other benefits beyond those explicitly disclosed herein.

The in-flight catering service platform system 110 can be a network-based platform (e.g., Internet) that is accessed and interacted with by a plurality of distributed users on an aircraft, depicted as airplane 150 in FIG. 1. For example, the airplane 150 can support Wi-Fi connectivity using technology such as air-to-ground or satellite-based Wi-Fi systems. The airplane's 150 Wi-Fi connectivity capabilities allows passengers and flight attendants to utilize mobile computer devices, such as smartphones, to wirelessly connect to a communication network 120, such as the Internet. FIG. 1 illustrates a mobile computer device 130, shown as a smartphone, which can be used during a flight by a passenger on the airplane 150; and a mobile computer device 140, also shown as a smartphone, which can be used during a flight by a flight attendant on the airplane 150. Subsequently, after a passenger connects to the Internet via the available inflight Wi-Fi, the passenger can use the passenger mobile application 135 that is installed on their mobile computer device 130 to access the catering service platform system 110 and utilize the system's 110 features, such as placing a mobile order for in-flight catering service while travelling on airplane 150. Similarly, a flight attendant that is servicing a flight on airplane 150 can use the in-flight Wi-Fi and the flight attendant mobile application 145 installed on their mobile computer device 140 to access the catering service platform system 110 and utilize the system's 110 features, such as starting and/or stopping in-flight catering services during the duration of the flight. It should be appreciated that the configuration in FIG. 1 serves as an example for purposes of discussion, and that in some embodiments, users of the in-flight catering service platform system 110 can employ the associated mobile applications 135, 145 on the ground pre-flight (e.g., prior to boarding airplane 150) or by using an offline configuration, in order to connect to the system 110 and use the features without requiring Wi-Fi connectivity of the aircraft. It should be appreciated that the features and capabilities of the in-flight catering service platform system 110, as disclosed herein, are not limited to aircraft, and thus can also be utilized in a wide-range of other applications that may be related to catering services (e.g., sale of food/beverage), such as trains, stadiums, events, restaurants, theater, venues, and the like, without departing from the scope of the embodiments.

Referring back to the example, the mobile computer devices 130, 140 can establish wireless connections to the in-flight catering service platform system 110 via the communication network 120, such as the Internet. Thus, the in-flight catering service platform system 110 can include a web-based platform that can be accessed remotely by a software applications (apps), depicted as passenger mobile application 135 and flight attendant mobile application 145, installed on the mobile computer devices 130, 140 respectively, in order to control aspects of the in-flight catering service process, such as placing a food/beverage order for a flight, updating the food/beverage inventory for a flight, and the like. FIG. 1 shows that a passenger's mobile computer device 130 can have a passenger's mobile application 135 installed thereon. Additionally, FIG. 1 shows that a flight attendant's mobile computer device 140 can have a flight attendant mobile application 145 installed thereon.

The communication network 120 can facilitate access and communication to global Wide Area Networks (WAN), such as the Internet, and supports any number of wireless communication protocols such as: WIFI, BLUETOOTH, ZIGBEE, cellular based protocols, and the like. It should be appreciated that the mobile computer devices 130, 140 may be implemented as various numbers of mobile and/or portable computing devices that are suitable for air travel, such as a smartphone, a tablet, a laptop, or a wearable device such as a smartwatch.

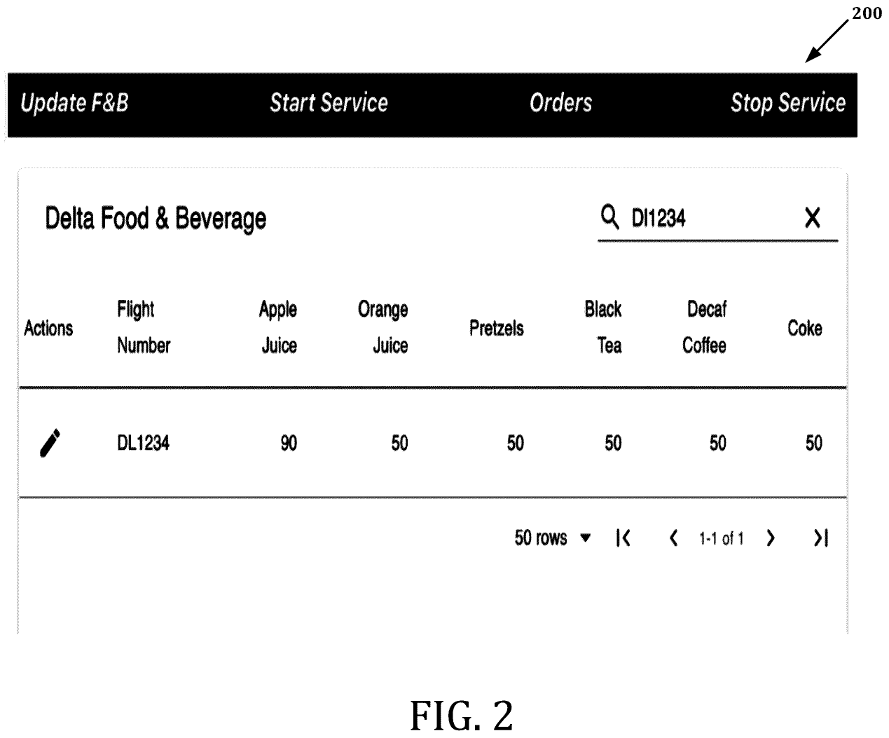

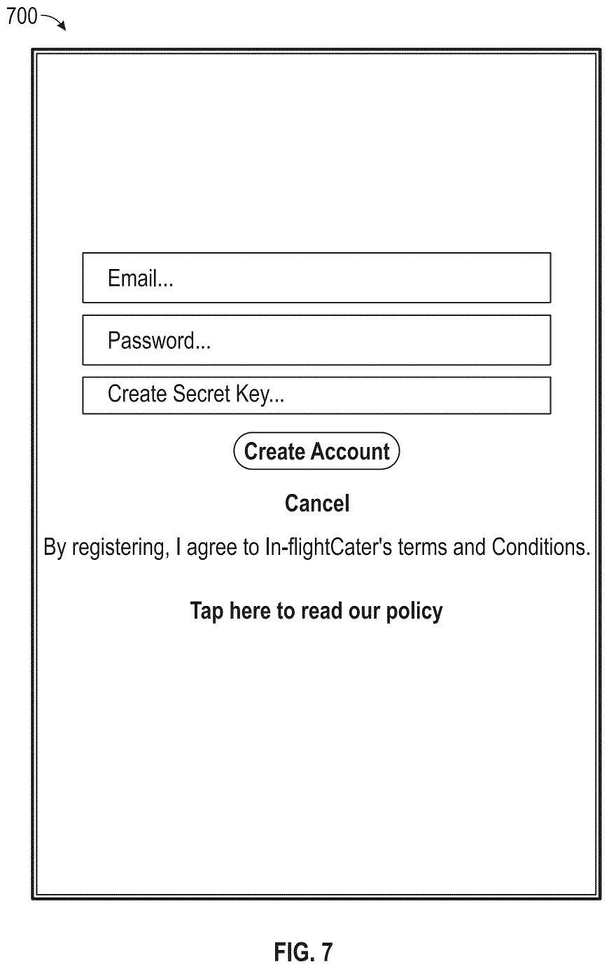

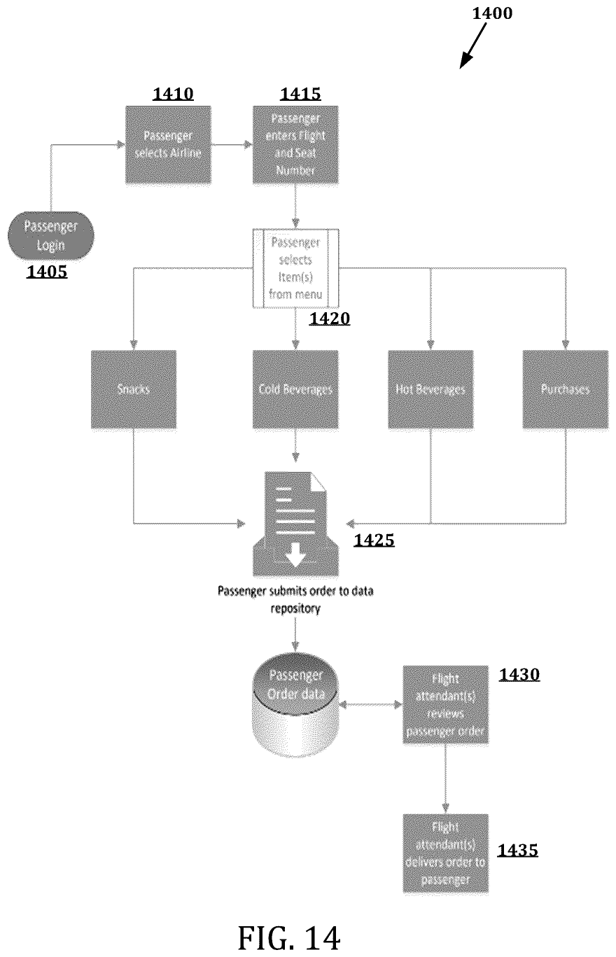

Accordingly, the mobile computer devices 130, 140 can utilize software applications, namely the passenger mobile application 135 and the flight attendant mobile application 145 respectively, that implement a graphical user interface (GUI) and user experience (UX) environments of the in-flight catering service platform system 110 to allow a user to access, view, and interact with its features over the distributed communication network 120 (e.g., Internet) while in-flight, for example while onboard airplane 150. Examples of GUIs that may be implemented by the flight attendant mobile application 145 that allows the airline staff, namely a flight attendant, to interact with various features supported by in-flight catering service platform system 110 are depicted in FIG. 2-FIG. 5. Examples of GUIs that may be implemented by the passenger mobile application 135 that allow a passenger on the airline to interact with various features supported by the in-flight catering service platform system 110 are depicted in FIG. 6— FIG. 13. It should be understood that the GUIs illustrated are merely exemplary and are not intended to be limiting. Accordingly, the in-flight catering service platform system 110, as disclosed herein, can support other GUIs and/or features that are not illustrated in FIG. 2-FIG. 13.

According to the embodiments, the passenger mobile application 135 is an element of the system's 110 platform that supports interactions for tasks that are associated with the passenger in the in-flight catering service process, such as selecting food and/or beverage items for the in-flight service. FIG. 1 depicts the passenger mobile application 135 as supporting features that include, but are not limited to: registering to the system 110 (e.g., create account, password resets, etc.); login to the system 110; submit passenger information (e.g., airline, flight number, set number, etc.) to the system 110; and submit/purchase in-flight order (e.g., selecting food, beverages, snacks, etc.). For example, a passenger can open the passenger mobile application 135 that is installed on their mobile computer device 130, namely smartphone, at any point in the flight to access the in-flight catering service platform system 110 and open a menu that is associated with the specific airline and flight that they are currently travelling on. Further, the passenger mobile application 135 allows the passenger to interact with the system 110, for instance selecting food, snacks, hot beverages, cold beverages, condiments, and the like directly from their smartphone, thereby automating the order taking process without requiring the passenger to speak with the flight attendant. In some embodiments, the passenger mobile application 135 even allows the passenger to complete purchase of their in-flight catering order via the system 110. For instance, the passenger can enter their payment information (e.g., credit card, debit card, etc.) or airline rewards/credits into the passenger mobile application 135 to cover any costs of the food and/or beverages ordered, which eliminates the need for an “in-person” interaction with the flight attendant for payment. Additional features that are enabled by the passenger mobile application 135 are further described in detail herein.

The flight attendant mobile application 145 is an element of the system's 110 platform that supports interactions for tasks that are associated with the flight attendant the in-flight catering service process, such as viewing/receiving orders for in-flight catering from multiple passengers on the flight. FIG. 1 depicts the flight attendant mobile application 145 as supporting features that include, but are not limited to: updating the inventory of food and/or beverages for the flight in the system 110 (e.g., create account, password resets, etc.); starting and/or stopping in-flight catering orders for the flight; accessing/reviewing in-flight catering orders from the passengers on the flight on the system 110; and searching orders/passengers/inventory information for the flight on the system 110. For example, a flight attendant can open the flight attendant mobile application 145 that is installed on their mobile computer device 140, namely smartphone, when it is most convenient for them (e.g., no other important jobs) during the flight to access the in-flight catering service platform system 110 and access all of the orders for in-flight catering that were submitted (to the system 110) by passengers onboard that flight attendant's flight. The flight-attendant mobile application 145 can present a GUI that allows the flight-attendant to perform a search (e.g., using the flight number associated with the airplane 150 they are servicing entered as a query) which displays an itemized list of each passenger order (e.g., seat number, food, snacks, beverages, etc.) that was submitted during that flight. Thus, the in-flight catering service platform system 110 allows in-flight catering orders to be submitted by passengers, and subsequently allows those orders to be viewed by flight attendants in an automated manner that removes much of the “in-person” contact from the in-flight catering services process. Additional features that are enabled by the flight attendant mobile application 145 are further described in detail herein.

The in-flight catering service platform system 110 can be a backend computer system(s), such as a server, which implements functionality and features that support computerized/automated in-flight catering services. FIG. 1 depicts that the in-flight catering service platform system 110 supporting features that include, but are not limited to: coordinating interactive communication between various elements of the system 110, such as the passenger mobile application 135 and the flight attendant mobile application 145; controlling the storing and access of in-flight catering service data (e.g., passenger names, airlines, flight numbers, seat numbers, orders, inventory information, etc.) entered into the system 110 by users; and security (e.g., verifying user accounts, firewalling information by airline (airlines cannot access data on the system 110 for other airlines), restricting access, etc.). A key feature of the in-flight catering service platform system 110 is providing access to in-flight catering service data to the distributed elements of the platform, such as the passenger mobile application 135 and the flight attendant mobile application 145.

For example, the in-flight catering service platform system 110 ensures that mobile in-flight catering orders for all of the passengers on a specific flight that (submitted via passenger mobile applications on their respective smartphones) are linked and appropriately accessed by the flight attendant mobile applications in use by the flight attendants for that same flight. In other words, the in-flight catering service platform system 110 ensures that the correct information is communicated to the proper users during the automated in-flight catering services process. To support these functions, information that is pertinent to in-flight catering services, such as user accounts (e.g., username, password), a passenger's flight information and in-flight order, flight numbers for each airline, inventory for each flight, can be stored and maintained by the system 110 on a storage system, illustrated as database 115. Consequently, the in-flight catering service platform system 110, as disclosed herein, provides a technology platform that consistently, efficiently, and interactively manages the end-to-end in-flight catering service process.

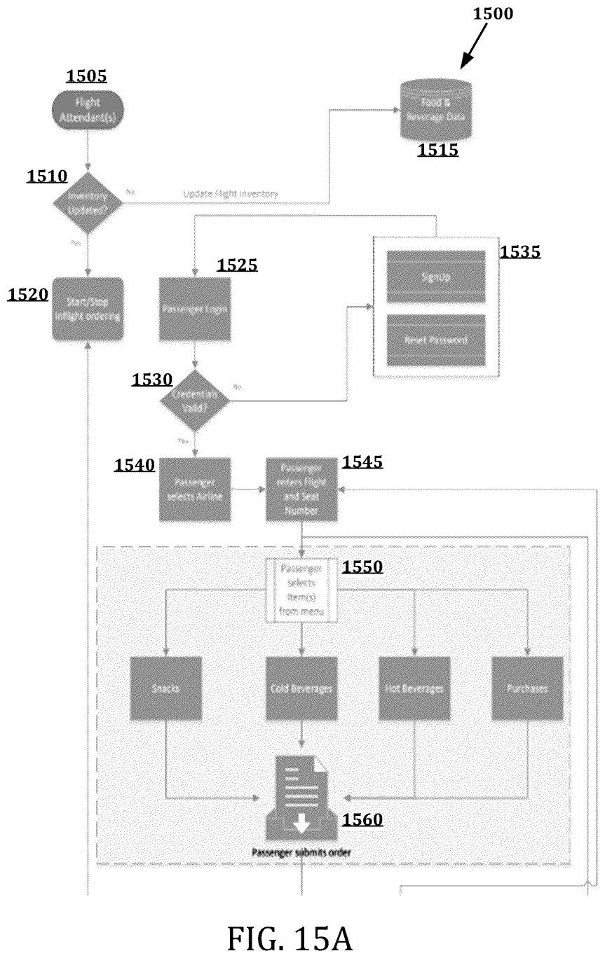

Referring now to FIG. 14, an example of a method 1400 for implementing aspects of the computer-based/automated in-flight catering services process, as disclosed herein, is shown. The method 1400 can be implemented via the in-flight catering services platform system (shown in FIG. 1).

The process 1400 begins at operation 1405, where the passenger performs a login into to the system. For example, the passenger can open a GUI supported by the passenger mobile application on their mobile computing device, and enters login information, such as their username/password and other credentials, via their device. If the passenger is verified as a registered user of the platform (e.g., credentials entered into the app match an account stored on the system), then the passenger can continue to access additional functions of the system.

Next, at operation 1410, the passenger can select an airline that is associated with their current air travel. For example, a passenger that is currently onboard a commercial Delta® flight can select that specific airline on their mobile computer device, via the passenger mobile application. Therefore, the system will only retrieve, and present options related to that selected airline for the passenger during this flight. Referring back to the example, the system will only allow the user to retrieve flight numbers, menus, and additional data for Delta® flights. Additionally, the system obtains (and can store) passenger-specific information that is relevant to the in-flight catering services process in an automated manner.

Next, at operation 1415, the passenger can enter their flight and seat number corresponding to their current flight. Again, the passenger can use the passenger mobile application to enter the flight number of their current flight, and the seat in which they occupy on the airplane into their mobile computer device. As a result, the system obtains additional passenger-specific information that is relevant to the in-flight catering service process in an automated manner. Furthermore, the passenger's seat number is subsequently used by the flight attendant to deliver the passenger their order during the flight.

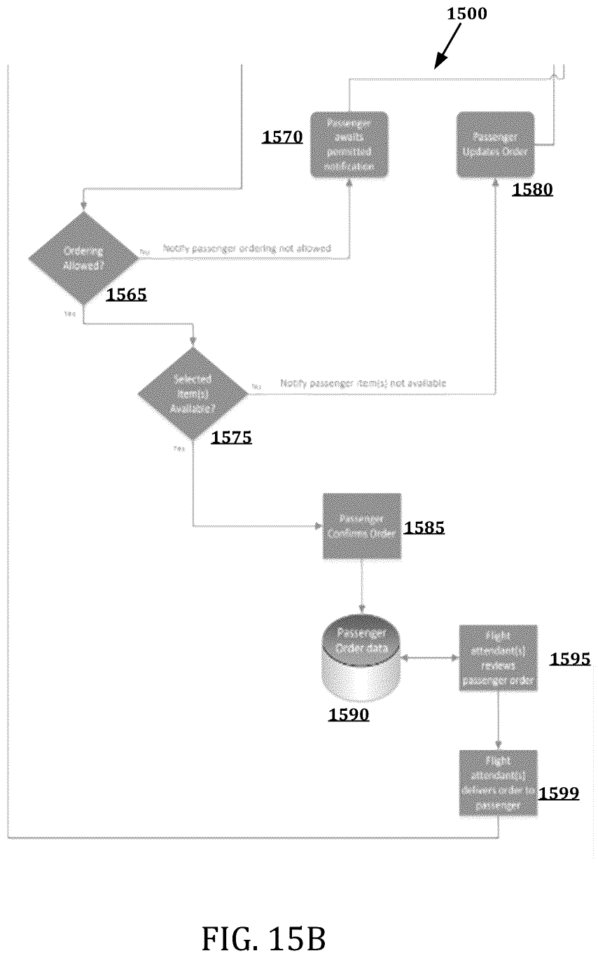

Subsequently, at operation 1420, the passenger selects one or more particular items from the menu for their in-flight catering service order. For example, based on the passenger's flight number and airline that were submitted to the system in previous operations 1415 and 1410 respectively, the system can retrieve and display a menu of food and/or beverage items that are particularly available on the passenger's flight. The menu can be displayed as a GUI by the passenger mobile application on the passenger' mobile computer device, where this GUI also allows interaction from the passenger to select certain items for their order. In other words, the GUI enables the passenger to create a mobile order for in-flight catering services, entirely using their mobile computer device and without directly speaking with a flight attendant. FIG. 15 illustrates that the passenger can add item to their order from different categories on the menu including: snacks, cold beverages, hot beverages; and purchases. In an embodiment, the menu presented in operation 1420 is based on the most current inventory update to the food and beverages that are available (in-stock) on the flight that have been submitted to the system by the flight-attendant working on that flight.

Continuing to operation 1425, after the passenger has completed their order for in-flight catering service (adding each item from the menu that they desire to be served during the flight), the passenger can submit the completed order to the system, which is stored in the system's repository. For instance, the GUI for creating a mobile order for in-flight catering services also include an interactive selection (e.g., button displayed on the screen) that allows the passenger to submit their order to the system. Accordingly, the system has electronically received and stored information that can be later retrieved and viewed by the flight attendant in order the provide the passenger's in-flight catering service. The system has the passenger's flight number, seat number, and each food, beverage, snack, etc. item that is included in their order. Thus, when the flight attendant later views all of the orders for the passengers on a current flight that are on the system, they can appropriately deliver the correct orders to the correct passengers, providing an efficient in-flight catering service process.

At operation 1430, the flight attendant can review the passenger's order for in-flight catering service, via the system. Operation 1430 can involve the flight attendant using the flight attendant mobile application in order to query, retrieve, and view all of the mobile orders for in-flight catering for the current flight on their mobile computer device as a computer-based/automated function. As previously described, the system has stored thereon the passenger's order for in-flight catering that was created in prior operation 1425. Subsequently, as the flight attendant views all of the in-flight catering orders for a specific flight number that are displayed on the flight attendant's mobile computer device, the flight attendant sees which food and/or beverages items have been requested for each passenger (by seat number). With this information, the flight attendant can physically deliver the order to a particular passenger, in operation 1435. For example, the flight attendant can electronically pull-up on their mobile computer device (e.g., displayed on the computer screen via the flight attendant mobile application) that the passenger at a certain seat number has ordered a candy bar and apple juice for their in-flight catering service order. Then, during the flight at a time that is most suitable, the flight attendant can bring those items to the passenger at that seat number, and without having to bother the passenger “in-person” for their order. Consequently, method 1400 achieves an efficient in-flight catering service process that is predominately computer-based/automated, requiring minimal “in-person” interactions.

FIG. 15 depicts an example of a method 1500 for implementing aspects of the computer-based/automated in-flight catering services process, as disclosed herein. The method 1500 can be implemented via the in-flight catering services platform system (shown in FIG. 1).

The method 1500 begins at operation 1505 where a flight attendant access the system, for example using the flight attendant mobile application.

Method 1500 continues to operation 1510 where the flight attendant can submit updates to the inventory of available food and/or beverage items for a specific flight to the system. If the flight attendant makes updates to the flight's inventory (e.g., out of apple juice) this data corresponding to the inventory update can be stored by the system, for instance in a repository.

Next, at operation 1520, the flight attendant can use the flight attendant mobile application to start and/or stop in-flight ordering.

At operation 1525, the passenger can perform a login attempt to access the system, for instance using the passenger mobile application. At operation 1530, the system can determine whether the credentials entered by the passenger at login (e.g., username, password, etc.) are valid. If the user's credentials are not valid, the method 1500 can move to operation 1535 to request the passenger signup to the system (e.g., create a new account) or reset their password. Alternatively, if the user's credentials are valid, the method 1500 can continue to operation 1540 where the system allows the passenger to access additional features and allows them to select the airline for corresponding to their flight via the passenger mobile application.

Next, at operation 1545, the passenger enters flight number and seat number corresponding to their flight via the passenger mobile application. Subsequently, at operation 1550, the passenger can select one or more items, such as snacks, cold beverages, hot beverages, and purchases, from a menu that is in the system for their specific flight (e.g., menu corresponding to flight number entered in operation 1545).

Method 1500 continues to operation 1560 where the passenger electronically submits their completed order for in-flight catering services, created on their mobile computer device and including their selected food and/or beverage items, to the system.

Process 1500 continues in FIG. 15B at operation 1565. At operation 1565, in response to the passenger submitting their order for in-flight catering, the system checks whether in-flight ordering is currently allowed for the flight (e.g., in-flight ordering started by the flight attendant via the flight attendant mobile application). If in-flight ordering is not currently allowed during the flight, then the system can provide a notification to the passenger, via their passenger mobile application, that in-flight ordering is not allowed at this point of the flight and the method 1500 proceeds to operation 1570 where the passenger waits to receive a notification when in-flight ordering is permitted.

Alternatively, when in-flight ordering is currently allowed during the flight, then the method 1500 goes to operation 1575 where the system determines if all of the items in the passenger's order are available on the flight. If one or more items in the passenger's order for in-flight catering is not currently available, then the system can provide a notification to the passenger, via their passenger mobile application, which items are not currently available and the method 1500 proceeds to operation 1580 where the passenger can update their order (e.g., selecting only items that are available).

Thereafter, at operation 1585, the passenger can confirm their order, for instance by viewing their selected items displayed on their mobile computer device via the passenger mobile application. In response to the passenger confirming their completed order, it can then be stored by the system at operation 1590.

Then, at operation 1595, the flight attendant can use the flight attendant mobile application to access the passenger's order on the system and review it. The flight attendant can then deliver the order that is has received on their mobile computer device (without speaking directly to the passenger) to the passenger sitting at their specified seat number, in operation 1599.

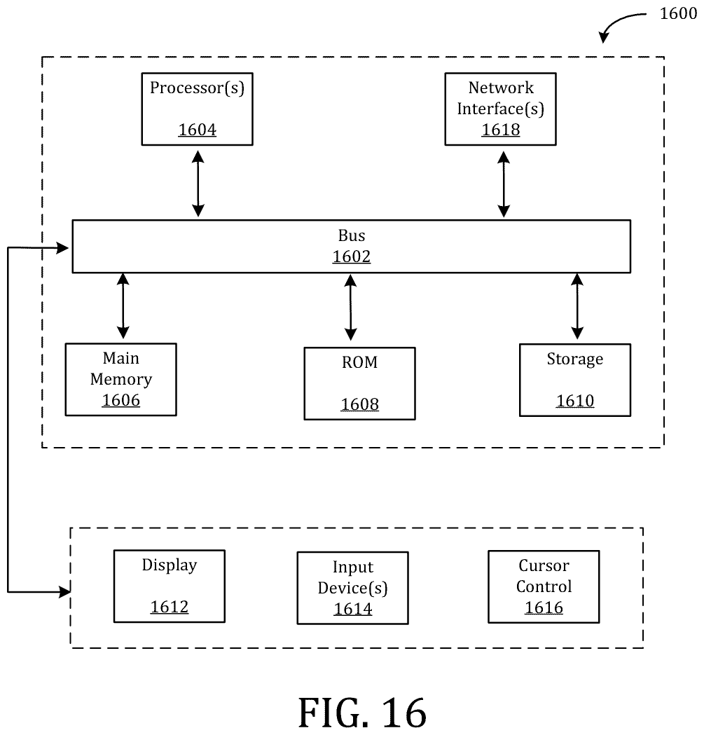

FIG. 16 depicts a block diagram of an example computer system 1600 in which the disclosed aspects of the in-flight catering service platform system (shown in FIG. 1) may be implemented. Furthermore, it should be appreciated that although the various instructions are illustrated as being co-located within a single processing unit, there may be some implementations in which processor(s) includes multiple processing units, allowing one or more instructions may be executed remotely from the other instructions.

The computer system 1600 includes a bus 1602 or other communication mechanism for communicating information, one or more hardware processors 1604 coupled with bus 1612 for processing information. Hardware processor(s) 1604 may be, for example, one or more general purpose microprocessors.

The computer system 1600 also includes a main memory 1606, such as a random-access memory (RAM), cache and/or other dynamic storage devices, coupled to bus 1602 for storing information and instructions to be executed by processor 1604. Main memory 1606 also may be used for storing temporary variables or other intermediate information during execution of instructions to be executed by processor 1604. Such instructions, when stored in storage media accessible to processor 1604, render computer system 1600 into a special-purpose machine that is customized to perform the operations specified in the instructions.

The computer system 1600 further includes a read only memory (ROM) 1608 or other static storage device coupled to bus 1602 for storing static information and instructions for processor 1604. A storage device 1610, such as a magnetic disk, optical disk, or USB thumb drive (Flash drive), etc., is provided and coupled to bus 1602 for storing information and instructions.

The computer system 1600 may be coupled via bus 1602 to a display 1612, such as a liquid crystal display (LCD) (or touch screen), for displaying information to a computer user. An input device 1614, including alphanumeric and other keys, is coupled to bus 1602 for communicating information and command selections to processor 1604. Another type of user input device is cursor control 1616, such as a mouse, a trackball, or cursor direction keys for communicating direction information and command selections to processor 1604 and for controlling cursor movement on display 1612. In some embodiments, the same direction information and command selections as cursor control may be implemented via receiving touches on a touch screen without a cursor.

The computing system 1600 may include a user interface module to implement a GUI that may be stored in a mass storage device as executable software codes that are executed by the computing device(s). This and other modules may include, by way of example, components, such as software components, object-oriented software components, class components and task components, processes, functions, attributes, procedures, subroutines, segments of program code, drivers, firmware, microcode, circuitry, data, databases, data structures, tables, arrays, and variables.

In general, the word “component,” “engine,” “system,” “database,” data store,” and the like, as used herein, can refer to logic embodied in hardware or firmware, or to a collection of software instructions, possibly having entry and exit points, written in a programming language, such as, for example, Python, Ruby on Rails or NodeJS. A software component may be compiled and linked into an executable program, installed in a dynamic link library, or may be written in an interpreted programming language such as, for example, BASIC, Perl, or Python. It will be appreciated that software components may be callable from other components or from themselves, and/or may be invoked in response to detected events or interrupts. Software components configured for execution on computing devices may be provided on a computer readable medium, such as a compact disc, digital video disc, flash drive, magnetic disc, or any other tangible medium, or as a digital download (and may be originally stored in a compressed or installable format that requires installation, decompression or decryption prior to execution). Such software code may be stored, partially or fully, on a memory device of the executing computing device, for execution by the computing device. Software instructions may be embedded in firmware, such as an EPROM. It will be further appreciated that hardware components may be comprised of connected logic units, such as gates and flip-flops, and/or may be comprised of programmable units, such as programmable gate arrays or processors.

The computer system 1600 may implement the techniques described herein using customized hard-wired logic, one or more ASICs or FPGAs, firmware and/or program logic which in combination with the computer system causes or programs computer system 1600 to be a special-purpose machine. According to one embodiment, the techniques herein are performed by computer system 1600 in response to processor(s) 1604 executing one or more sequences of one or more instructions contained in main memory 1606. Such instructions may be read into main memory 1606 from another storage medium, such as storage device 1610. Execution of the sequences of instructions contained in main memory 1606 causes processor(s) 1604 to perform the process steps described herein. In alternative embodiments, hard-wired circuitry may be used in place of or in combination with software instructions.

The term “non-transitory media,” and similar terms, as used herein refers to any media that store data and/or instructions that cause a machine to operate in a specific fashion. Such non-transitory media may comprise non-volatile media and/or volatile media. Non-volatile media includes, for example, optical or magnetic disks, such as storage device 1610. Volatile media includes dynamic memory, such as main memory 1606. Common forms of non-transitory media include, for example, a floppy disk, a flexible disk, hard disk, solid state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge, and networked versions of the same.

Non-transitory media is distinct from but may be used in conjunction with transmission media. Transmission media participates in transferring information between non-transitory media. For example, transmission media includes coaxial cables, copper wire and fiber optics, including the wires that comprise bus 1602. Transmission media can also take the form of acoustic or light waves, such as those generated during radio-wave and infra-red data communications.

The computer system 1600 also includes a communication interface 1618 coupled to bus 1602. Network interface 1618 provides a two-way data communication coupling to one or more network links that are connected to one or more local networks. For example, communication interface 1618 may be an integrated services digital network (ISDN) card, cable modem, satellite modem, or a modem to provide a data communication connection to a corresponding type of telephone line. As another example, network interface 1618 may be a local area network (LAN) card to provide a data communication connection to a compatible LAN (or WAN component to communicate with a WAN). Wireless links may also be implemented. In any such implementation, network interface 1618 sends and receives electrical, electromagnetic or optical signals that carry digital data streams representing various types of information.

A network link typically provides data communication through one or more networks to other data devices. For example, a network link may provide a connection through local network to a host computer or to data equipment operated by an Internet Service Provider (ISP). The ISP in turn provides data communication services through the worldwide packet data communication network now commonly referred to as the “Internet.” Local networks and Internet both use electrical, electromagnetic or optical signals that carry digital data streams. The signals through the various networks and the signals on network link and through communication interface 1618, which carry the digital data to and from computer system 1610, are example forms of transmission media.

The computer system 1600 can send messages and receive data, including program code, through the network(s), network link and communication interface 1618. In the Internet example, a server might transmit a requested code for an application program through the Internet, the ISP, the local network and the communication interface 1618.

The received code may be executed by processor 1604 as it is received, and/or stored in storage device 1610, or other non-volatile storage for later execution.

In various implementations, operations that are performed “in response to” or “as a consequence of” another operation (e.g., a determination or an identification) are not performed if the prior operation is unsuccessful (e.g., if the determination was not performed). Operations that are performed “automatically” are operations that are performed without user intervention (e.g., intervening user input). Features in this document that are described with conditional language may describe implementations that are optional. In some examples, “transmitting” from a first device to a second device includes the first device placing data into a network for receipt by the second device but may not include the second device receiving the data. Conversely, “receiving” from a first device may include receiving the data from a network but may not include the first device transmitting the data.

Each of the processes, methods, and algorithms described in the preceding sections may be embodied in, and fully or partially automated by, code components executed by one or more computer systems or computer processors comprising computer hardware. The one or more computer systems or computer processors may also operate to support performance of the relevant operations in a “cloud computing” environment or as a “software as a service” (SaaS). The processes and algorithms may be implemented partially or wholly in application-specific circuitry. The various features and processes described above may be used independently of one another or may be combined in various ways. Different combinations and sub-combinations are intended to fall within the scope of this disclosure, and certain method or process blocks may be omitted in some implementations. The methods and processes described herein are also not limited to any particular sequence, and the blocks or states relating thereto can be performed in other sequences that are appropriate, or may be performed in parallel, or in some other manner. Blocks or states may be added to or removed from the disclosed example embodiments. The performance of certain operations or processes may be distributed among computer systems or computer processors, not only residing within a single machine, but deployed across a number of machines.

While the specification includes examples, the disclosure's scope is indicated by the following claims. Furthermore, while the specification has been described in language specific to structural features and/or methodological acts, the claims are not limited to the features or acts described above. Rather, the specific features and acts described above are disclosed as examples for embodiments of the disclosure.

Insofar as the description above and the accompanying drawing disclose any additional subject matter that is not within the scope of the claims below, the disclosures are not dedicated to the public and the right to file one or more applications to claims such additional disclosures is reserved.

The following is claimed:

1. A system, comprising:
a first computer device associated with a first user at a location;
a second computer associated with a second user at the location;
a server communicatively connected to the first computer device and the second communication device via a communication network, wherein the server:
coordinates interactive communication between the first computer device and the second computer device enabling catering services for the location.

2. The system of claim 1, wherein the location comprises at least one of: an aircraft, a train, a stadium, a restaurant, a theater, and a venue.

3. The system of claim 2, wherein the first user first user is a flight attendant on the aircraft and the first computer device comprises a mobile computer device having a flight attendant in-flight catering application installed thereon.

4. The system of claim 3, wherein the flight attendant in-flight catering application submits input to start in-flight catering service from the flight attendant.

5. The system of claim 4, wherein the server receives the input to start in-flight catering service from the flight attendant in-flight catering application.

6. The system of claim 3, wherein the second user is a passenger on the aircraft.

7. The system of claim 6, wherein the second computer comprises a mobile computer device having a passenger in-flight catering application installed thereon.

8. The system of claim 7, wherein the passenger in-flight catering application receives passenger information submitted by the passenger.

9. The system of claim 8, wherein the passenger information comprises one or more of: airline, flight number, and seat number.

10. The system of claim 9, wherein the server receives the passenger information from the passenger in-flight catering application and retrieves corresponding in-flight catering service options based on the passenger information for the passenger in-flight catering application.

11. The system of claim 10, wherein the passenger in-flight catering application submits an in-flight catering service order from passenger.

12. The system of claim 11, wherein the server receives the in-flight catering service order from the passenger in-flight catering application and provides the in-flight catering service order to the flight attendant in-flight catering application.

13. The system of claim 12, wherein the flight attendant in-flight catering application displays the in-flight catering service order and the corresponding seat number for the passenger.

14. The system of claim 3, wherein the flight attendant in-flight catering application enables querying, retrieving, and viewing of one or more in-flight catering service orders for the aircraft.

15. The system of claim 14, wherein the flight attendant in-flight catering application displays each in-flight catering service order by a corresponding seat number on the aircraft.

16. The system of claim 1, wherein the location comprises at least one of: an aircraft, a train, a stadium, an event, a restaurant, a theater, and a venue.

17. A method, comprising:
receiving passenger information corresponding to a passenger on a flight;
retrieving one or more in-flight catering service options for the flight based on the passenger information;
receiving an order selected by the passenger from the one or more in-flight catering service options for the flight; and
retrieving the order and the passenger information corresponding to the passenger to be viewed by a flight-attendant on the flight.

18. The method of claim 17, wherein the passenger information comprises one or more of: airline, flight number, and seat number.

19. The method of claim 18, wherein the order for the passenger is viewed by a flight-attendant on the flight based on the corresponding seat number.

20. An in-flight catering service platform system, the system comprising:
a first mobile computer device comprising a passenger mobile application, wherein the passenger mobile application is associated with a passenger on a flight;
a second mobile computer device comprising a flight attendant mobile application, wherein the passenger mobile application is associated with a passenger on a flight;
a server that can be accessed remotely by the passenger mobile application and the flight attendant mobile application, wherein the server stores a set of instructions that when executed cause the server to:
start and shut down in-flight catering service for a flight;
receive orders for in-flight catering service for passengers on the flight;
update inventory for the in-flight catering service on the flight; and
retrieve the orders for in-flight catering service for passengers on the flight.
